(19) United States
(12) Patent Application Publication
(10) Pub. No.: US 2012/0075639 A1
(43) Pub. Date: Mar. 29, 2012

(54) IMAGING SYSTEMS AND METHODS INCORPORATING NON-MECHANICAL SCANNING BEAM ACTUATION

(76) Inventors: JEFFREY BRENNAN, Los Angeles, CA (US); Jian Ren, Pasadena, CA (US)

(21) Appl. No.: 13/241,755

(22) Filed: Sep. 23, 2011

Related U.S. Application Data
(60) Provisional application No. 61/386,468, filed on Sep. 24, 2010.

(51) Int. Cl. G01B 9/02

(52) U.S. Cl. 356/479

(57) ABSTRACT

In various embodiments, optical-imaging systems incorporate non-mechanical beam-actuation systems to facilitate the acquisition of, e.g., two- and three-dimensional images.

### RELATED APPLICATION

This application claims the benefit of and priority to U.S. Provisional Patent Application No. 61/386,468, filed Sep. 24, 2010, the entire disclosure of which is hereby incorporated herein by reference.

### FIELD OF THE INVENTION

In various embodiments, the present invention relates to optical coherence tomography (OCT) and other imaging systems, in particular such systems incorporating non-mechanical beam-scanning capabilities.

### BACKGROUND

Advances in minimally invasive surgical procedures and the development of novel surgical instruments have enabled surgeons to access delicate areas of the body that were previously off-limits or only accessible through highly invasive procedures. In addition, new diagnostic techniques—including new or improved imaging modalities—provide surgeons with more information and a better understanding of the area being treated. This enables surgeons to collect, for example, real-time and non-destructive biopsies and analyze regions that are typically difficult to access. These innovations have resulted in significant improvements in treatment options and patient outcomes for a variety of maladies.

One such useful diagnostic technique is optical coherence tomography (“OCT”), an interferometric technique for noninvasive diagnosis and imaging utilizing (typically near-infrared) light. OCT has transformed the field of ophthalmology and promises to have a similar impact on a variety of other medical specialties. OCT systems have become a mainstay in hospitals and ophthalmology clinics for diagnostic evaluation and imaging purposes. Furthermore, advances in technology have enabled smaller imaging devices (e.g., handheld endoscopic probes) that provide minimally invasive imaging of regions of interest not accessible using external imaging devices.

A particularly useful mode of OCT, termed “B-scan,” provides two-dimensional axial depth scans of the tissue of interest (somewhat analogous to ultrasound imaging but with improved resolution capabilities), thus providing an accurate visual representation of the tissue under examination, including information on the identity, size, and depth of subsurface features. Three-dimensional images of the tissue under examination, termed “C-scans,” may be formed by “stacking” multiple B-scans.

B-scan formation typically requires the scanning of an optical beam (e.g., a laser) across the surface of interest. For example, a surgeon may hold an OCT probe (from which the optical beam emanates) and move his or her hand to sweep the optical beam across the sample of interest. Alternately, the sample may be moved while the probe is held stationary. Both of these techniques are inherently problematic. In the first case, the surgeon's hand movement (both intentional and movements caused by hand tremor) may be unsteady and thus result in unwanted distortion. Such distortion may render the resulting image useless for diagnostic purposes. In the second case, it may be difficult to move the sample (e.g., a patient's eye) in a manner conducive to capturing useful images.

Therefore, scanning mechanisms have been used to provide B-scan and C-scan imaging functionality; these mechanisms include galvanometer-based mirror scanners, MEMS-based scanners, rotating lens-based scanners, and other mechanical actuation systems. These mechanical systems also suffer from inherent weaknesses; the moving parts are prone to failure, may produce frictional heat, may require maintenance, may be overly complex or bulky (thus preventing miniaturization), and are often slow (requiring the patient to remain motionless for up to several minutes during an image capture). Thus, there is a need for optical imaging systems and techniques that do not rely on mechanical actuation systems.

### SUMMARY

In accordance with embodiments of the present invention, optical probes such as OCT probes, and/or external scanners not utilized endoscopically, incorporate non-mechanical beam-actuation systems. As utilized herein, the term “non-mechanical” refers to systems that do not utilize moving mechanical parts such as gears, motors, and/or actuators, and instead manipulate an optical beam by other means, e.g., by application of an electric field. In a specific embodiment, the beam-actuation system incorporates one or more electro-optic materials (i.e., materials having optical properties, such as absorption and/or refractive index, that change upon application of an electric field) to rapidly and accurately scan and/or focus the optical beam. The electro-optic materials may be utilized in conjunction with or instead of focusing optics such as gradient-index (GRIN) lenses. Embodiments of the present invention do not utilize the acousto-optic effect for optical beam modulation.

Herein, the term “probe” refers to functionality rather than necessarily to a distinct physical apparatus. Accordingly, probes or probe functions may be implemented in separate, dedicated apparatus, or in a single physical structure providing the different functions. Probes may each be driven or controlled by a single driver, or instead, multiple (or even all) probes may be controlled by a single driver selectably actuable to provide the various functions.

In one aspect, embodiments of the invention feature an optical probe system including or consisting essentially of a light source, a detector, an interferometer, a handpiece, and an electro-optic scanning mechanism. The interferometer is in optical communication with the light source and the detector. The handpiece communicates an optical beam from the light source to the sample and has an aperture at a tip thereof through which the optical beam is communicated to the sample. The electro-optic scanning mechanism is disposed within the handpiece and steers the optical beam with respect to the sample without relative motion between the handpiece and the sample, thereby imaging at least a portion of the sample in at least two dimensions.

As described herein, steering of the optical beam in one dimension images the sample in two dimensions (e.g., provides a B-scan image), steering of the optical beam in two dimensions (e.g., a raster scan or an arbitrary x-y scan) images the sample in three dimensions, etc.

Embodiments of the invention may include one or more of the following, in any of a variety of combinations. The electro-optic scanning mechanism may include or consist essentially of a first electro-optic material and at least one electrode for applying a voltage thereto, the optical beam being focused, defocused, and/or deflected in response to the voltage. The first electro-optic material may include or consist essentially of KTa₁₋ₓNbₓO₃ where 0<x<1, lithium niobate, lithium tantalate, bismuth silicon oxide, ammonium dihydrogen phosphate, potassium dihydrogen phosphate, potassium dideuterium phosphate, cadmium telluride, barium titanate, and/or a material incorporating one or more organic chromophores. At least one electrical lead for communication electric current to the electrode(s) may be disposed within the handpiece. A collimating lens for collimating the optical beam may be disposed in the optical path of the optical beam between the light source and the first electro-optic material. The collimating lens may include or consist essentially of a gradient-index lens. A focusing lens for focusing the optical beam may be disposed in the optical path of the optical beam between the first electro-optic material and the aperture. The focusing lens may include or consist essentially of a gradient-index lens.

A second electro-optic material for focusing the deflected optical beam and at least one electrode for applying a voltage to the second electro-optic material may be disposed in the optical path of the optical beam between the first electro-optic material and the aperture. The second electro-optic material may include or consist essentially of KTa₁₋ₓNbₓO₃ where 0<x<1, lithium niobate, lithium tantalate, bismuth silicon oxide, ammonium dihydrogen phosphate, potassium dihydrogen phosphate, potassium dideuterium phosphate, cadmium telluride, barium titanate, and/or a material incorporating one or more organic chromophores. An offset lens for offsetting the focus of the focused deflected optical beam may be disposed in the optical path of the optical beam between the second electro-optic material and the aperture. The offset lens may include or consist essentially of a gradient-index lens. A relay lens for communicating the defected optical beam toward the aperture may be disposed in the optical path of the optical beam between the first electro-optic material and the aperture. The deflection of the deflected optical beam entering the relay lens may be substantially equal to the deflection of the deflected optical beam exiting the relay lens. The relay lens may include or consist essentially of an integral-pitch lens or a half-integral-pitch lens. The relay lens may include or consist essentially of a gradient-index lens. A focusing lens for focusing the deflected optical beam may be disposed in the optical path of the optical beam between the relay lens and the aperture.

A lens may be disposed in the optical path of the optical beam between the first electro-optic material and the aperture. The lens may include or consist essentially of (i) a relay segment for communicating the deflected optical beam toward the aperture, a deflection of the deflected optical beam entering the relay segment being substantially equal to the deflection of the deflected optical beam exiting the relay segment, and (ii) a focusing segment for focusing the deflected optical beam. The handpiece tip may be flexible. The handpiece tip may include therewithin, disposed in the optical path of the optical beam between the first electro-optic material and the aperture, (i) a relay lens for communicating the deflected optical beam toward the aperture, a deflection of the deflected optical beam entering the relay lens being substantially equal to the deflection of the deflected optical beam exiting the relay lens, and/or (ii) a focusing lens for focusing the deflected optical beam. The relay lens and/or the focusing lens may include or consist essentially of a flexible gradient-index optical fiber. The handpiece tip may include or consist essentially of a hollow wire of a shape-memory alloy (e.g., an alloy of nickel and titanium). The wire may be pre-shaped with a desired curvature, and the handpiece tip may include an outer sleeve disposed around the wire and slidably removable from the wire; the wire may assume the desired curvature upon removal of the outer sleeve.

In another aspect, embodiments of the invention feature an imaging method utilizing an optical probe system that includes a handpiece for communicating an optical beam to a sample to be imaged. The tip of the handpiece is disposed proximate the sample, and an electro-optic scanning mechanism is directed to steer the optical beam with respect to the sample without relative motion between the handpiece and the sample, thereby imaging at least a portion of the sample in at least two dimensions. The imaging may include or consist essentially of optical coherence tomography imaging.

These and other objects, along with advantages and features of the invention, will become more apparent through reference to the following description, the accompanying drawings, and the claims. Furthermore, it is to be understood that the features of the various embodiments described herein are not mutually exclusive and can exist in various combinations and permutations. As used herein, the term “substantially” means±10%, and, in some embodiments, ±5%. The term “consists essentially of” means excluding other materials that contribute to function, unless otherwise defined herein. Nonetheless, such other materials may be present, collectively or individually, in trace amounts.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIGS. 1 and 2 are schematic diagrams of components of OCT interferometry systems in accordance with various embodiments of the invention;

FIG. 3 is a schematic cross-section of an optical probe incorporating non-mechanical beam-scanning capability in accordance with various embodiments of the invention;

FIG. 4A depicts a light beam deflected from its initial path via the influence of an electro-optic material, in accordance with various embodiments of the invention;

FIG. 4B depicts a light beam being focused via the influence of an electro-optic material, in accordance with various embodiments of the invention; and

FIGS. 5-8 are schematic cross-sections of optical probes incorporating non-mechanical beam-scanning capability in accordance with various other embodiments of the invention.

### DETAILED DESCRIPTION

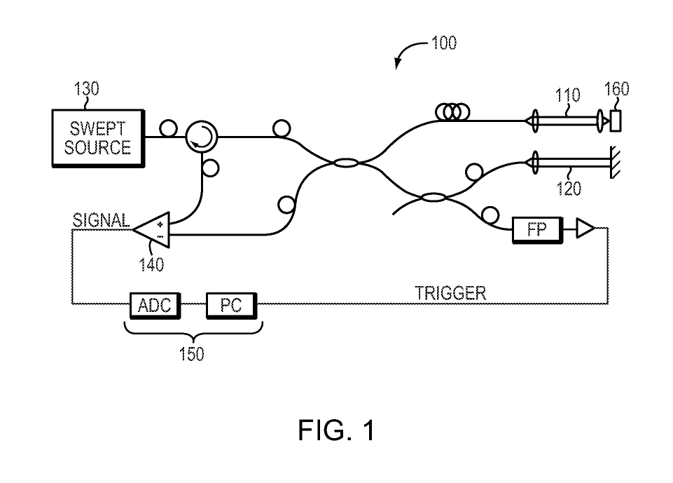

FIG. 1 depicts an exemplary OCT interferometry system 100 utilized in accordance with embodiments of the present invention, although alternative systems with similar functionality, as well as non-OCT optical probes, are also within the scope of the invention. As depicted, OCT interferometry system 100 includes a sample arm (or “probe”) 110, a reference arm 120, a light source 130, a photodetector 140, and data-acquisition and processing hardware (or “driver”) 150. Light from light source 130 travels through optical fibers to probe 110 and reference arm 120. Via probe 110, the light illuminates a sample 160, which may include or consist essentially of, e.g., biological tissue. Various features of interest of sample 160 reflect the light in different amounts or from different depths. The reflected light is combined with light reflected by reference arm 120 (which typically includes or consists essentially of a mirror), and the interference pattern thus generated provides information about the spatial dimensions and location of structures within sample 160. Light source 130 may include or consist essentially of one or more lasers or light-emitting diodes (LEDs) and may be, e.g., a swept-source or tunable laser or a superluminescent diode (e.g., for use with a spectrometer-based detector). Although only one light source is depicted in FIG. 1, various embodiments of the invention incorporate multiple light sources. Such other light sources impart additional functionality to OCT interferometry system 100, as described in U.S. patent application Ser. No. 12/718,186, filed Mar. 5, 2010 (the '186 application), the entire disclosure of which is incorporated by reference herein. In a typical medical imaging application, the sample arm is the only component of the OCT interferometry system 100 that requires positioning in contact with or in close proximity to the area to be imaged (e.g., the eye).

Hardware 150 may be a personal-computer- (PC-) based architecture, and may include a high-speed analog-to-digital converter (for example, on a PCI bus) that digitizes the output of photodetector 140 (which may be a spectrometer-based detector, e.g., for use with a superluminescent light source) at a sampling rate ranging from several million samples per second to several billion samples per second. In an embodiment, the digitized data is processed by the PC processor and readily available or straightforwardly implemented software that, e.g., performs a Fourier transform and conventional signal processing and reconstruction algorithms on the data. In another embodiment the data processing is performed in dedicated hardware, e.g., an application-specific integrated circuit (ASIC), field-programmable gate array (FPGA), digital signal processor (DSP), graphics processing unit (GPU), or combination of these devices. The hardware and/or associated software derives, e.g., reconstructed images, biometric measurements, and/or quantitative data from the data produced by OCT interferometry system 100.

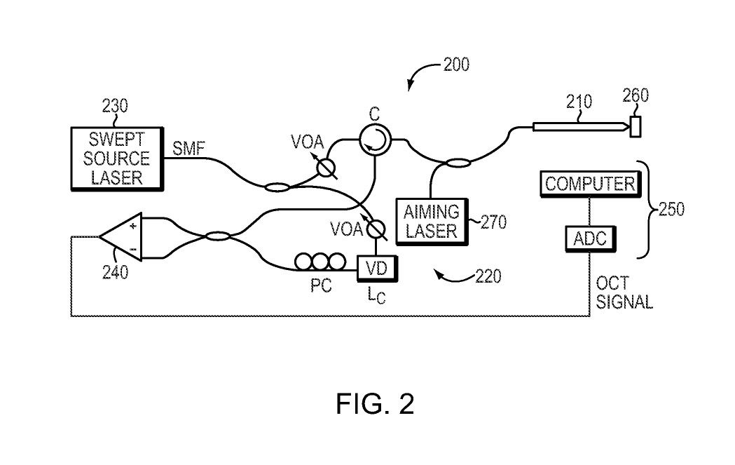

FIG. 2 depicts an OCT system in accordance with various alternative embodiments of the invention. As shown, an OCT interferometry system 200 includes a probe 210, a reference arm 220, a light source 230, a photodetector 240, and a driver 250. Light from light source 230 travels through optical fibers (e.g., single-mode optical fibers) to probe 210 and reference arm 220. Via probe 210, the light illuminates a sample 260, which may include or consist essentially of, e.g., biological tissue. The reflected light is combined with light reflected by reference arm 220, and the interference pattern thus generated provides information about the spatial dimensions and location of structures within sample 260. Light source 230 may include or consist essentially of one or more lasers or light-emitting diodes (LEDs) and may be, e.g., a swept-source or tunable laser or a superluminescent diode. In addition, due to the fact that the light source 230 typically operates in the non-visible infrared spectrum, some embodiments of the present invention include a mechanism for visualizing the location and scan path of the beam. An embodiment of the probe includes a visible aiming light source 270 (e.g., a laser such as a 632 nm-wavelength laser) inserted into the light path through the use of an optical combiner or wavelength-division multiplexer. As the probe scans across a sample, the visible light beam translates with the OCT light beam, facilitating location of the beam's position. The visible beam may also be used to convey information to the user (e.g., a surgeon), for example by changing colors (e.g., through the use of an RGB source, a large variety of colors may be formed), changing the timing of the beam (e.g., blinking at different rates to indicate different information), or even spatially (scanning visible patterns for the user to see (e.g., indicating an area of interest with a red laser that is sweeping in a circular fashion or projecting an “X” to indicate a point of interest).

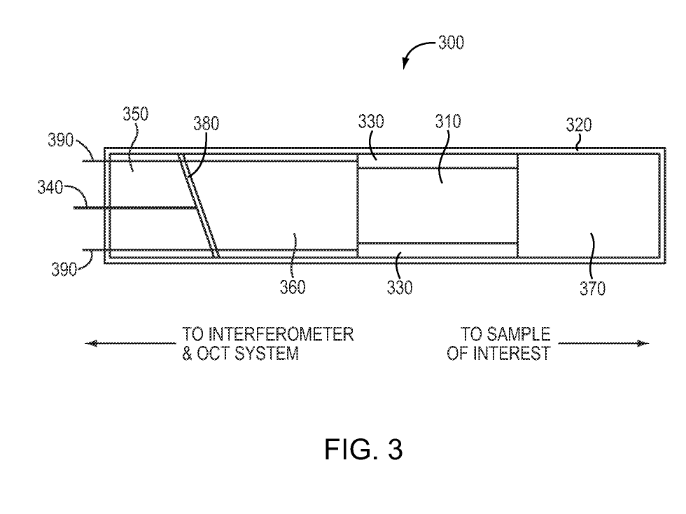

As depicted in FIGS. 3-8, embodiments of the invention feature a handheld probe as the interferometer sample arm. The probe may be used endoscopically, e.g., in a minimally invasive procedure to image the retina. Various embodiments include a non-mechanical scanning-actuation system in the probe in order to enable, e.g., B-scan and/or C-scan functionality. FIG. 3 schematically depicts a probe 300 that incorporates an electro-optic material 310 (e.g., an electro-optic crystal) such as KTa₁₋ₓNbₓO₃ where 0<x<1 (KTN), lithium niobate, lithium tantalate, bismuth silicon oxide, ammonium dihydrogen phosphate, potassium dihydrogen phosphate, potassium dideuterium phosphate, cadmium telluride, barium titanate, and/or organic electro-optic materials, e.g., materials incorporating organic chromophores (which are typically dipolar (charge-transfer) molecules consisting of an electron donor, an electron acceptor, and a π-electron bridge providing communication between the donor and acceptor moieties; see, e.g., U.S. Pat. No. 7,307,173, the entire disclosure of which is hereby incorporated by reference). As described herein, the electro-optic material may be utilized (e.g., via application of an electric field with one or more electrodes) to deflect and/or vary the focal length of the optical probe light beam (e.g., via the Kerr Effect) in a highly-controllable fashion.

The electro-optic material 310 is preferably disposed within a tube 320, e.g., an endoscopic tube or needle. Tube 320 may include or consist essentially of surgical-grade steel and/or an electrically insulating material such as polyimide or polyether ether ketone (PEEK). Probe 300 also includes one or more (preferably two or more) electrodes 330 utilized to apply a voltage (and the resulting electric field) to the electro-optic material 310. The electrodes 300 each preferably include or consist essentially of one or more electrically conductive materials, e.g., metal or an organic conductor. The light beam utilized for, e.g., OCT preferably enters probe 300 via an optical fiber 340, which may include or consist essentially of a single-mode optical fiber (e.g., SMF-28 Optical Fiber available from Corning Incorporated of Corning, N.Y.). The fiber 340 may be coupled into the probe 300 via a ferrule 350 (e.g., a glass ferrule) or other suitable coupling mechanism.

In other embodiments, the electro-optic material 310 is disposed within a larger housing designed for external non-endoscopic imaging but utilizing features similar to those of the endoscopic systems (e.g., one or more features described herein).

In various embodiments, probe 300 incorporates a collimating lens 360 (e.g., a GRIN lens) to collimate the light emanating from the fiber 340, as well as a focusing lens 370 (e.g., a GRIN lens) to focus the light after it has passed through the electro-optic material 310. One or both of the collimating lens 360 and the focusing lens 370 may include or consist essentially of, e.g., glass or plastic, and either or both of the lenses may be either press-fit within tube 320 or secured with a biocompatible epoxy or other adhesive or sealant. The interface 380 between the ferrule 350 and the collimating lens 360 may be angle cut (e.g., at approximately 8°) to minimize back reflection; alternatively, the surfaces of the ferrule 350 and the collimating lens 360 meeting at interface 380 may be substantially flat (i.e., 0°), and an index-matching material (e.g., an index-matching gel) may optionally be disposed at interface 380 to minimize back reflections. An anti-reflective coating may even be applied to the surfaces of the ferrule 350 and the collimating lens 360. One or more electrical leads 390 may extend through probe 300 and supply electric current to the electrodes 330.

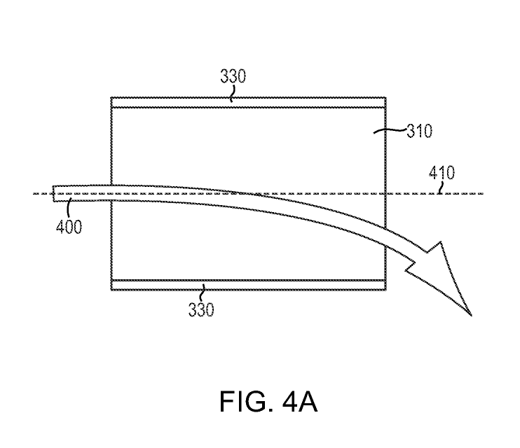

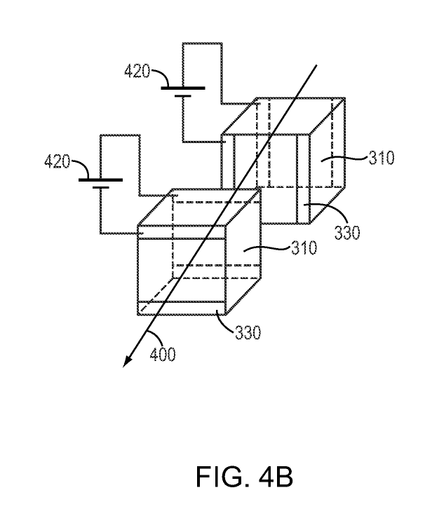

FIG. 4A illustrates deflection of a light beam 400 travelling through the electro-optic material 310 while an electric field is applied via electrodes 330. As shown, under the influence of the electro-optic material 310, the path of the light beam 400 is deflected from its initial direction 410 by an amount dependent at least in part on the specific electro-optic material 310 in probe 300, the amount of voltage applied to the electrodes 330, the dimensions (e.g., the length along the path of light 400) of the electro-optic material 310, and the number and configuration of the electrodes 330. A variety of scanning geometries are possible based on combinations of such factors.

In addition, as also detailed below and as depicted in FIG. 4B, variable focal depth is achievable by adjusting the electric field distribution. For example, the voltage distribution to multiple electrodes 330 surrounding the electro-optic material 310 may be varied in order to vary the depth of focus of the light beam 400 exiting the probe. FIG. 4B illustrates one configuration in which focal-depth variation (focusing) is accomplished. As shown, the electrodes 330 are oriented such that the electric field distribution lines (e.g., arising from voltage applied by voltage sources 420) are parallel with the axis of propagation of the light beam 400. In contrast, in beam deflection applications, the electric field lines typically intersect the axis of light propagation. In embodiments in which the electro-optic material 310 is utilized to focus the light beam 400, the focusing lens 370 may be omitted.

As the electric field is modified (e.g., via separate drive electronics controlling power to electrodes 330) the path of the light beam 400 is altered, as shown in FIG. 4A. Linear scan patterns (i.e., B-scans) and alternative scanning patterns (e.g., volumetric scans that provide three-dimensional imaging capabilities) are readily achievable in various embodiments, and scanning speeds of, e.g., 100-1000 kHz may be achieved.

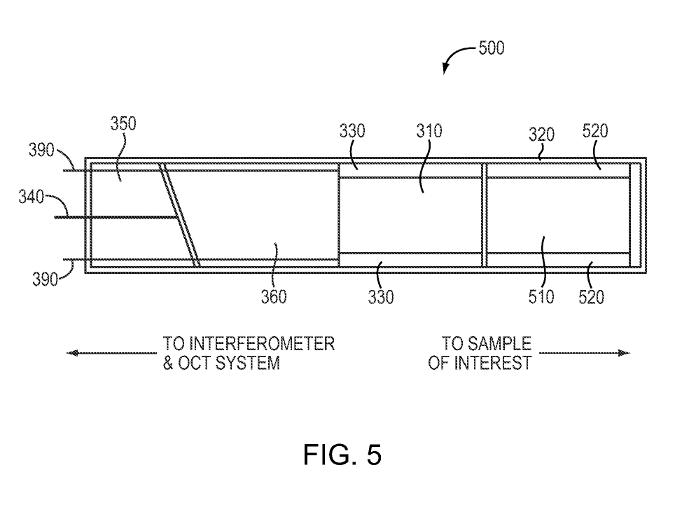

Various embodiments of the present invention replace the focusing lens (e.g., focusing lens 370 described above) with a second electro-optic material (which may include or consist essentially of any one or more of the materials detailed above with reference to electro-optic material 310). FIG. 5 depicts a probe 500 having such a configuration, in which an electro-optic material 510 replaces the focusing lens 370. As shown, the probe 500 may incorporate one or more electrodes 520 for application of voltage to the electro-optic material 510, as well as one or more electrical leads (not shown) supplying electrical connectivity thereto. Thus, probe 500 features distinct electro-optic materials (which may include or consist essentially of the same or different material(s)) for scanning the optical beam and for focusing the optical beam.

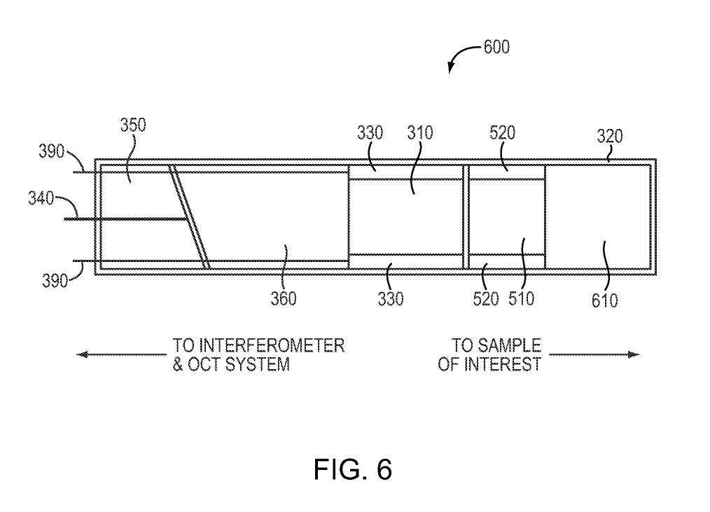

The probe 600 depicted in FIG. 6 is similar to probe 500 but incorporates an additional focusing lens 610 to, e.g., provide a focusing offset for the light beam travelling through probe 600. That is, the focusing lens 610 provides a specific initial depth of focus for the light beam exiting probe 600, and the electro-optic material 510 is utilized (as detailed above) to alter the focus of the light relative to that initial focus point (i.e., to offset the focus of the light).

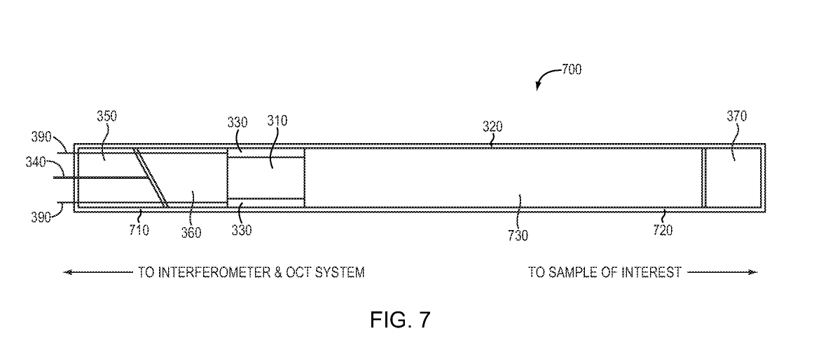

In various embodiments, the current supplied to electrodes 330 and/or electrodes 520 ranges from approximately 1 μA to approximately 100 μA. However, the supplied voltage is generally fairly high, e.g., ranging from approximately 10 V to approximately 10,000 V. Thus, some embodiments of the present invention distance the electro-optic material and/or the electrodes applying voltage thereto away from the tip of the probe (and thus farther away from the patient or issue being imaged). FIG. 7 depicts a probe 700 in which the electro-optic material 310 is disposed at or near a proximal end 710, while a distal end 720 is utilized in or near the issue being imaged. As shown, after the light is deflected by the influence of the electro-optic material 310, the light is propagated to the distal end 720 via a propagation lens 730 (which may be a GRIN lens). In preferred embodiments, the propagation lens 730 includes or consists essentially of a single-pitch (or integer multiple thereof) lens such that the light beam follows substantially the same path entering and exiting the propagation lens 730. In other embodiments, the propagation lens 730 includes or consists essentially of a half-pitch (or integer multiple thereof) lens, such that the light beam exiting the propagation lens 730 is rotated 180° compared to its direction entering propagation lens 730. After exiting propagation lens 730, the light may be focused by the focusing lens 370. In some embodiments, the focusing lens 370 is omitted, and a single lens both propagates and focuses the light beam after its deflection by the electro-optic material 310, thus simplifying manufacture and decreasing cost of probe 700. In such embodiments, the propagation lens typically incorporates a segment that is a single- or half-pitch (or integral multiple thereof) for propagating the optical beam, as well as a segment for focusing the optical beam (the length of which may or may not be an integral multiple of the single- or half-wavelength of the deflected light). Probe 700 (and/or other probes described herein) may also incorporate current-limiting circuitry that maintain the current levels in the device to levels safe for patient contact in the case of accidental exposure.

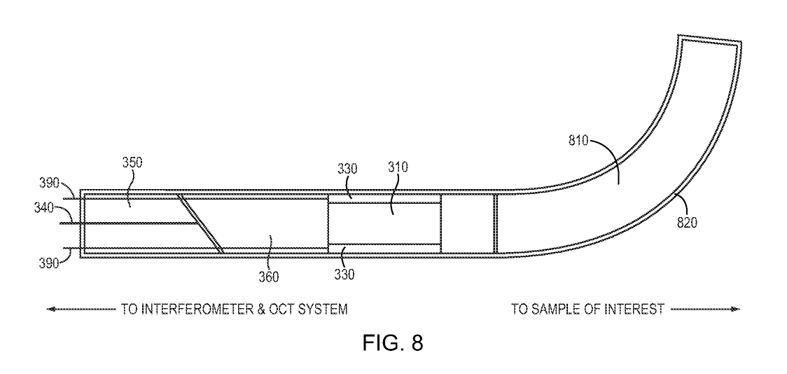

Various embodiments of the present invention are at least partially flexible endoscopic probes useful for, e.g., certain medical-imaging applications. As shown in FIG. 8, a probe 800 incorporates at least a portion of a propagation lens and/or a focusing lens (generally referred to herein as lens 810) within a substantially flexible tube or needle 820. Tube 820 may include or consist essentially of a plastic such as polyimide and/or PEEK. Lens 810 may include or consist essentially of a substantially flexible GRIN optical fiber that propagates and/or focuses the deflected light beam and relays it to the sample being imaged. Tube 820 may be moved and/or directed along or toward a specific direction of interest that may lie outside of the direct path parallel to the non-flexible portions of probe 800, thus dramatically increasing the volume of tissue that may be imaged from a single position and conformation of probe 800. The motion of tube 820 (i.e., independent of any motion of the remaining portions of probe 800) may be controlled via any of a variety of mechanisms, including mechanical and/or electrical actuation. In an embodiment, tube 820 includes or consists essentially of a shape-memory material (e.g., an alloy of nickel and titanium, i.e., nitinol, an alloy of copper, nickel, and aluminum, and/or an alloy of copper, nickel, aluminum, and zinc) that is preferably biocompatible with the tissue to be imaged. The tube 820 may be disposed within an outer sleeve that is straight (i.e., parallel to the non-flexible portions of probe 800) and that may be easily inserted into the region of interest via, e.g., a cannulated incision. After insertion into the sample, the tube 820 may be extended out of the outer sleeve; the tube 820 may have been pre-shaped with a desired curvature that enables images (e.g., OCT images) to be captured at an angle relative to the long axis of probe 800. As described above with respect to propagation lens 730, the lens 810 may be single- or half-pitch (or an integral multiple thereof) to propagate the optical beam at a direction equivalent to (or rotated 180° from) its angle of propagation into lens 810.

Various other embodiments of the invention replace or supplement the electro-optical materials detailed herein with liquid crystals configured as an optical phase array, where application of voltage thereto enables similar scanning and focusing capabilities.

Embodiments of the invention incorporate additional optical functionalities and/or non-optical diagnostic and/or therapeutic functionality into the optical probe, as described in the '186 application. Furthermore, various embodiments may be incorporated into distributed OCT systems, as described in U.S. patent application Ser. No. 13/106,388, filed May 12, 2011, the entire disclosure of which is incorporated by reference herein. Embodiments may also combine OCT (or other optical) imaging and surgical manipulation capabilities into a single tool, as described in U.S. patent application Ser. No. 13/106,390, filed May 12, 2011, the entire disclosure of which is incorporated by reference herein. Embodiments of the invention may also be utilized to perform any of a variety of diagnostic procedures, as described in U.S. patent application Ser. No. 12/718, 266, filed Mar. 5, 2010, the entire disclosure of which is incorporated by reference herein.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. An optical probe system comprising:
a light source;
a detector;
an interferometer in optical communication with the light source and the detector;
for communicating an optical beam from the light source to a sample, a handpiece having an aperture at a tip thereof through which the optical beam is communicated to the sample; and
disposed within the handpiece, an electro-optic scanning mechanism for steering the optical beam with respect to the sample without relative motion between the handpiece and the sample, thereby imaging at least a portion of the sample in at least two dimensions.

2. The system of claim 1, wherein the electro-optic scanning mechanism comprises a first electro-optic material and at least one electrode for applying a voltage thereto, the optical beam being focused or defocused in response to the voltage.

3. The system of claim 1, wherein the electro-optic scanning mechanism comprises a first electro-optic material and at least one electrode for applying a voltage thereto, the optical beam being deflected in response to the voltage.

4. The system of claim 3, wherein the first electro-optic material comprises at least one of KTa₁₋ₓNbₓO₃ where 0<x<1, lithium niobate, lithium tantalate, bismuth silicon oxide, ammonium dihydrogen phosphate, potassium dihydrogen phosphate, potassium dideuterium phosphate, cadmium telluride, barium titanate, or a material incorporating one or more organic chromophores.

5. The system of claim 3, further comprising, disposed within the handpiece, at least one electrical lead for communicating electric current to the at least one electrode.

6. The system of claim 3, further comprising, disposed in an optical path of the optical beam between the light source and the first electro-optic material, a collimating lens for collimating the optical beam.

7. The system of claim 6, wherein the collimating lens comprises a gradient-index lens.

8. The system of claim 3, further comprising, disposed in an optical path of the optical beam between the first electro-optic material and the aperture, a focusing lens for focusing the optical beam.

9. The system of claim 8, wherein the focusing lens comprises a gradient-index lens.

10. The system of claim 3, further comprising, for focusing the deflected optical beam and disposed in an optical path of the optical beam between the first electro-optic material and the aperture, (i) a second electro-optic material and (ii) at least one electrode for applying a voltage thereto.

11. The system of claim 10, wherein the second electro-optic material comprises at least one of KTa₁₋ₓNbₓO₃ where 0<x<1, lithium niobate, lithium tantalate, bismuth silicon oxide, ammonium dihydrogen phosphate, potassium dihydrogen phosphate, potassium dideuterium phosphate, cadmium telluride, barium titanate, or a material incorporating one or more organic chromophores.

12. The system of claim 10, further comprising, disposed in the optical path of the optical beam between the second electro-optic material and the aperture, an offset lens for offsetting a focus of the focused deflected optical beam.

13. The system of claim 12, wherein the offset lens comprises a gradient-index lens.

14. The system of claim 3, further comprising, disposed in an optical path of the optical beam between the first electro-optic material and the aperture, a relay lens for communicating the deflected optical beam toward the aperture, a deflection of the deflected optical beam entering the relay lens being substantially equal to the deflection of the deflected optical beam exiting the relay lens.

15. The system of claim 14, wherein the relay lens is an integral-pitch lens.

16. The system of claim 14, wherein the relay lens is a half-integral-pitch lens.

17. The system of claim 14, wherein the relay lens comprises a gradient-index lens.

18. The system of claim 14, further comprising, disposed in the optical path of the optical beam between the relay lens and the aperture, a focusing lens for focusing the deflected optical beam.

19. The system of claim 3, further comprising, disposed in an optical path of the optical beam between the first electro-optic material and the aperture, a lens comprising (i) a relay segment for communicating the deflected optical beam toward the aperture, a deflection of the deflected optical beam entering the relay segment being substantially equal to the deflection of the deflected optical beam exiting the relay segment, and (ii) a focusing segment for focusing the deflected optical beam.

20. The system of claim 3, wherein the handpiece tip is flexible and comprises therewithin, disposed in an optical path of the optical beam between the first electro-optic material and the aperture, at least one of (i) a relay lens for communicating the deflected optical beam toward the aperture, a deflection of the deflected optical beam entering the relay lens being substantially equal to the deflection of the deflected optical beam exiting the relay lens, or (ii) a focusing lens for focusing the deflected optical beam.

21. The system of claim 20, wherein the at least one said relay lens or focusing lens comprises a flexible gradient-index optical fiber.

22. The system of claim 20, wherein the handpiece tip comprises a hollow wire of a shape-memory alloy.

23. The system of claim 22, wherein the wire has been pre-shaped with a desired curvature, and wherein the handpiece tip comprises an outer sleeve disposed around the wire and being slidably removable from the wire, the wire assuming the desired curvature upon removal of the outer sleeve.

24. The system of claim 22, wherein the shape-memory alloy comprises an alloy of nickel and titanium.

25. An imaging method utilizing an optical probe system comprising a handpiece for communicating an optical beam to a sample to be imaged, the method comprising:
disposing a tip of the handpiece proximate the sample; and
causing an electro-optic scanning mechanism to steer the optical beam with respect to the sample without relative motion between the handpiece and the sample, thereby imaging at least a portion of the sample in at least two dimensions.

26. The method of claim 25, wherein the imaging comprises optical coherence tomography imaging.
